(19) United States
(12) Patent Application Publication
(10) Pub. No.: US 2016/0260202 A1
(43) Pub. Date: Sep. 8, 2016

(54) IMAGE PROCESSING DEVICE, AND DISPLAY DEVICE

(71) Applicant: Seiko Epson Corporation, Tokyo (JP)

(72) Inventors: Manabu Saigo, Matsumoto-shi (JP); Shiki Furui, Matsumoto-shi (JP)

(21) Appl. No.: 15/053,517

(22) Filed: Feb. 25, 2016

(30) Foreign Application Priority Data
Mar. 2, 2015 (JP) 2015-040607

(51) Int. Cl. G06T 5/00; H04N 5/262; G06T 3/40

(52) U.S. Cl. CPC G06T 5/006; G06T 3/4007; H04N 5/2628

(57) ABSTRACT

An image processing device adapted to perform a deformation of an image converts a coordinate of a pixel constituting the image into a coordinate on a post-deformation image obtained by deforming the image, associates the pixel constituting the post-deformation image with the pixel constituting the image based on a coordinate on the post-deformation image of the pixel constituting the image, inputs pixel data of the pixel constituting a deformation target image, identifies the pixel, which constitutes the post-deformation image, and is associated with the pixel constituting the image and identified based on the pixel data input, and then outputs a pixel position in the post-deformation image of the pixel identified, and a pixel value determined based on a pixel value of the pixel data input as a pixel position and a pixel value of an output pixel.

The entire disclosure of Japanese Patent Application No. 2015-040607, filed Mar. 2, 2015 is expressly incorporated by reference herein.

### BACKGROUND

1. Technical Field

The present invention relates to an image processing device, and a display device.

2. Related Art

There has been known a device for performing a correction of changing the shape of an image to be displayed on a display section (see, e.g., JP-A-11-331737). JP-A-11-331737 discloses a projector for performing a keystone distortion correction as a typical example of a geometric correction.

In many cases, since the arrangement of the pixels varies when performing the correction of deforming the shape of the image such as a keystone distortion correction to the image, the pixel values of the pixels constituting the image having been corrected are obtained from the pixel values of the image having not been corrected using arithmetic processing. In the arithmetic processing, there is used, for example, an interpolation process based on the pixel values of the pixels constituting the image. In this interpolation process, it is necessary to refer to a plurality of pixels of the image, and further, if a conversion process such as expansion, contraction, or rotation is added, the range of the pixels to be referred to is further increased. Therefore, in the past, a frame memory for storing the image has been disposed in an anterior stage of the processing section for performing the correction, and the processing section has read the image from the frame memory to perform the interpolation process.

However, in the correction of deforming the shape of the image, there is a problem that if the number of the pixels, the pixel values of which need to be read, is large, there increases a band load of a bus, which connects the frame memory and the processing section for performing the correction of deforming the shape.

### SUMMARY

An advantage of some aspects of the invention is to provide an image processing device and a display device each capable of efficiently performing deformation of an image while suppressing the number of pixels to be referred to for the deformation of the image.

An image processing device according to an aspect of the invention is an image processing device adapted to perform a deformation of an image, the image processing device including a conversion section adapted to convert a coordinate of a pixel constituting the image into a coordinate on a post-deformation image obtained by deforming the image, an association section adapted to associate the pixel constituting the post-deformation image with the pixel constituting the image based on a coordinate on the post-deformation image of the pixel constituting the image, and an output section adapted to input pixel data of the pixel constituting a deformation target image, identify the pixel, which constitutes the post-deformation image, and is associated with the pixel constituting the image and identified based on the pixel data input, and then output a pixel position in the post-deformation image of the pixel identified, and a pixel value determined based on a pixel value of the pixel data input as a pixel position and a pixel value of an output pixel.

According to the aspect of the invention, it is possible to suppress the number of pixels to be referred to for the deformation of the image to efficiently perform the deformation of the image.

In the image processing device according to the aspect of the invention, the output section may sequentially input the pixel data of the pixels constituting the deformation target image, and then output the pixel position and the pixel value of each of the corresponding output pixels in the order of inputting the pixel data.

According to the aspect of the invention with this configuration, since the output pixels are output in the order of inputting the pixel data, the deformation of the image can efficiently be performed.

In the image processing device according to the aspect of the invention, the association section may select a pixel, which is located in an area surrounded by coordinates on the post-deformation image of a plurality of pixels constituting the image, and a coordinate value of which on the post-deformation image is an integer, as a pixel constituting the post-deformation image, and associate a pixel, which is the closest to the pixel constituting the post-deformation image, and the coordinate of which on the post-deformation image is selected out of the plurality of pixels, with the pixel, which constitutes the post-deformation image, and is selected.

According to the aspect of the invention with this configuration, the association between the pixel constituting the post-deformation image and the pixel constituting the image can easily be performed.

An image processing device according to another aspect of the invention is an image processing device adapted to perform a deformation of an image, the image processing device including a conversion section adapted to convert a coordinate of a pixel constituting the image into a coordinate on a post-deformation image obtained by deforming the image, a selection section adapted to select an output pixel constituting the post-deformation image based on the coordinate on the post-deformation image of the pixel constituting the image, an association section adapted to associate a coordinate of the output pixel with a coordinate on the image, and a calculation section adapted to calculate a pixel value of the output pixel based on the coordinate on the image of the output pixel.

According to the aspect of the invention with this configuration, since it is sufficient to refer to the pixels constituting the image based on the coordinates on the post-deformation image, it is possible to suppress the number of the pixels to be referred to for the deformation of the image to efficiently perform the deformation of the image.

In the image processing device according to the aspect of the invention, the selection section may select the pixel, which is located in an area surrounded by coordinates on the post-deformation image of a plurality of pixels constituting the image, and a coordinate value of which is an integer, as the output pixel.

According to the aspect of the invention with this configuration, the association between the output pixel and the pixel constituting the image can easily be performed.

In the image processing device according to the aspect of the invention, the conversion section may convert a coordinate of the pixel constituting the image into a coordinate on the post-deformation image based on a linear transformation.

According to the aspect of the invention with this configuration, the coordinate of the pixel constituting the image can easily be converted into the coordinate on the post-deformation image.

In the image processing device according to the aspect of the invention, the association section may convert the coordinate of the output pixel into the coordinate on the image based on an affine transformation.

According to the aspect of the invention with this configuration, the coordinate of the output pixel can easily be converted into the coordinate on the image.

A display device according to another aspect of the invention is a display device adapted to perform a deformation of an image to display on a display section, the display device including a conversion section adapted to convert a coordinate of a pixel constituting the image into a coordinate on a post-deformation image obtained by deforming the image, an association section adapted to associate the pixel constituting the post-deformation image with the pixel constituting the image based on a coordinate on the post-deformation image of the pixel constituting the image, an output section adapted to input pixel data of the pixel constituting a deformation target image, identify the pixel, which constitutes the post-deformation image, and is associated with the pixel constituting the image and identified based on the pixel data input, and then output a pixel position in the post-deformation image of the pixel identified, and a pixel value determined based on a pixel value of the pixel data input as a pixel position and a pixel value of an output pixel, and an image processing section adapted to generate the post-deformation image based on the pixel position and the pixel value of the output pixel input from the output section to display on the display section.

According to the aspect of the invention, it is possible to suppress the number of pixels to be referred to for the deformation of the image to efficiently perform the deformation of the image.

A display device according to another aspect of the invention is a display device adapted to perform a deformation of an image to display on a display section, the display device including a conversion section adapted to convert a coordinate of a pixel constituting the image into a coordinate on a post-deformation image obtained by deforming the image, a selection section adapted to select an output pixel constituting the post-deformation image based on the coordinate on the post-deformation image of the pixel constituting the image, an association section adapted to associate a coordinate of the output pixel with a coordinate on the image, a calculation section adapted to calculate a pixel value of the output pixel based on the coordinate on the image of the output pixel, and an image processing section adapted to form the post-deformation image based on the coordinate of the output pixel and the pixel value of the output pixel to display the post-deformation image on the display section.

According to the aspect of the invention, since it is sufficient to refer to the pixels constituting the image based on the coordinates on the post-deformation image, it is possible to suppress the number of the pixels to be referred to for the deformation of the image to efficiently perform the deformation of the image.

A method of controlling an image processing device according to another aspect of the invention is a method of controlling an image processing device adapted to perform a deformation of an image, the method including converting a coordinate of a pixel constituting the image into a coordinate on a post-deformation image obtained by deforming the image, associating the pixel constituting the post-deformation image with the pixel constituting the image based on a coordinate on the post-deformation image of the pixel constituting the image, inputting pixel data of the pixel constituting a deformation target image to identify a pixel constituting the post-deformation image associated with the pixel constituting the image identified based on the pixel data input, and outputting a pixel position in the post-deformation image of the pixel identified and a pixel value determined based on a pixel value of the pixel data input as a pixel position and a pixel value of an output pixel.

According to the aspect of the invention, it is possible to suppress the number of pixels to be referred to for the deformation of the image to efficiently perform the deformation of the image.

A method of controlling an image processing device according to another aspect of the invention is a method of controlling an image processing device adapted to perform a deformation of an image, the method including converting a coordinate of a pixel constituting the image into a coordinate on a post-deformation image obtained by deforming the image, selecting an output pixel constituting the post-deformation image based on the coordinate on the post-deformation image of the pixel constituting the image, associating a coordinate of the output pixel with a coordinate on the image, and calculating a pixel value of the output pixel based on the coordinate on the image of the output pixel.

According to the aspect of the invention, since it is sufficient to refer to the pixels constituting the image based on the coordinates on the post-deformation image, it is possible to suppress the number of the pixels to be referred to for the deformation of the image to efficiently perform the deformation of the image.

### BRIEF DESCRIPTION OF THE DRAWINGS

The invention will be described with reference to the accompanying drawings, wherein like numbers reference like elements.

FIG. 1 is a block diagram of a projector according to a first embodiment.

FIG. 2 is a configuration diagram of an image processing section of the first embodiment.

FIGS. 3A and 3B are explanatory diagrams of a calculation method of coordinate conversion information, wherein FIG. 3A is a diagram showing a pre-correction image, and FIG. 3B is a diagram showing a post-correction image.

FIG. 4 is a flowchart showing a processing procedure of a geometric correction section of the first embodiment.

FIGS. 5A and 5B are explanatory diagrams of a geometric correction process, wherein FIG. 5A is an enlarged view of a block A, which is one of blocks constituting the pre-correction image, and FIG. 5B is an enlarged view of the block A in the post-correction image.

FIGS. 6A and 6B are explanatory diagrams of the geometric correction process, wherein FIG. 6A is a diagram showing four pixels selected in the block A, and FIG. 6B is a diagram showing pixel positions of the selected four pixels on which the geometric correction has been performed.

FIGS. 7A and 7B are explanatory diagrams of the geometric correction process, wherein FIG. 7A is a diagram showing an output pixel surrounded by the four pixels on the post-correction image, and FIG. 7B is a diagram showing the state in which the four pixels and the output pixel are restored to the state in which the correction has not been performed.

FIG. 8 is an explanatory diagram of an interpolation process.

FIG. 9 is a configuration diagram of an image processing section of a second embodiment.

FIG. 10 is a flowchart showing a processing procedure of a geometric correction section of the second embodiment.

### DESCRIPTION OF EXEMPLARY EMBODIMENTS

### First Embodiment

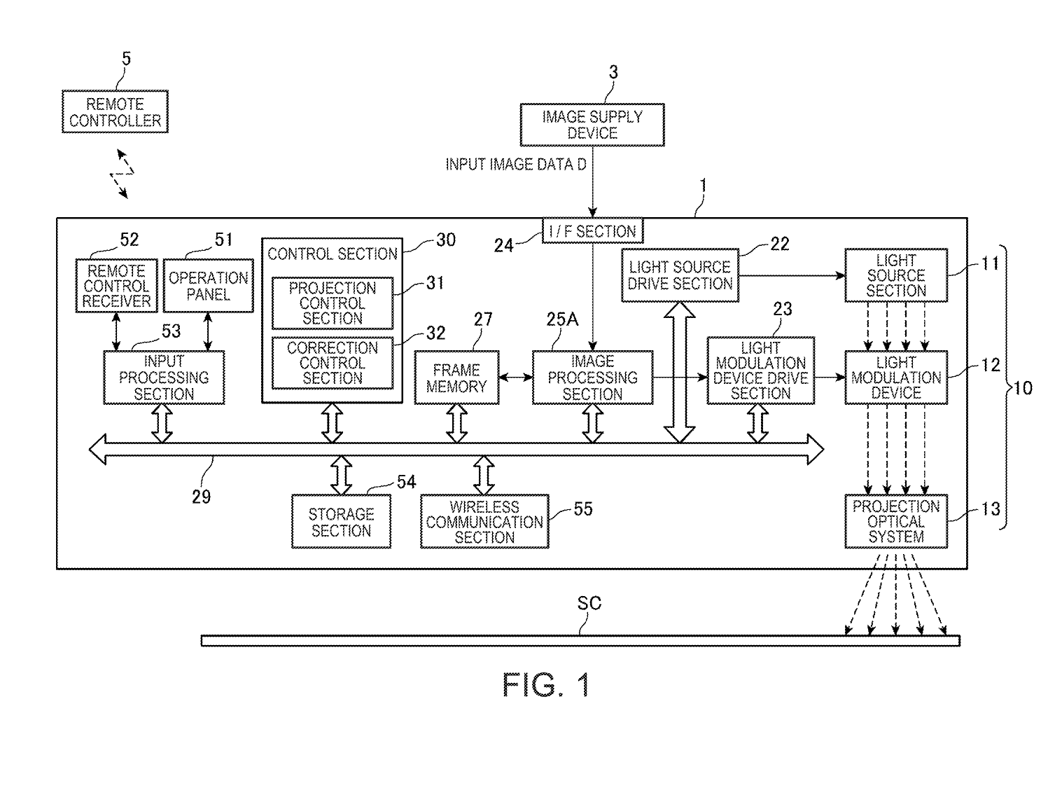

FIG. 1 is a block diagram of a projector 1 according to a first embodiment.

The projector 1 (an image processing device) is a device connected to an image supply device 3 located in the outside such as a personal computer or a variety of types of video players, and for projecting an image, which is based on input image data D input from the image supply device 3, on a target object. As such an image supply device 3, there can be cited a video output device such as a video reproduction device, a DVD (digital versatile disk) reproduction device, a television tuner device, a set-top box for a CATV (cable television), or a video game device, a personal computer, and so on. Further, the target object can also be an object which is not evenly flat such as a building or a body, or can also be an object having a flat projection surface such as a screen SC or a wall surface of a building. In the present embodiment, the case in which the projection is performed on a flat screen SC will be illustrated.

The projector 1 is provided with an I/F (interface) section 24 as an interface to be connected to the image supply device 3. As the I/F section 24, there can be used, for example, a DVI interface, a USB interface, and a LAN interface to which a digital video signal is input. Further, as the I/F section 24, there can be used, for example, an S-video terminal to which a composite video signal such as NTSC, PAL, or SECAM is input, an RCA terminal to which a composite video signal is input, or a D terminal to which a component video signal is input. Further, as the I/F section 24, there can be used a multipurpose interface such as an HDMI connector compliant to the HDMI (registered trademark) standard. Further, it is also possible to adopt a configuration in which the I/F section 24 has an A/D conversion circuit for converting an analog video signal into digital image data, and is connected to the image supply device 3 with an analog video terminal such as a VGA terminal. It should be noted that it is also possible for the I/F section 24 to perform transmission/reception of the image signal using wired communication, or to perform transmission/reception of the image signal using wireless communication.

The projector 1 is provided with a display section 10 for performing optical image formation, and an image processing system for electrically processing the image to be displayed by the display section 10 in a general classification. Firstly, the display section 10 will be described.

The display section 10 is provided with a light source section 11, a light modulation device 12, and a projection optical system 13.

The light source section 11 is provided with a light source formed of a xenon lamp, a super-high pressure mercury lamp, a light emitting diode (LED), or the like. Further, the light source section 11 can also be provided with a reflector and an auxiliary reflector for guiding the light emitted by the light source to the light modulation device 12. Further, the light source section 11 can be a device provided with a lens group for enhancing the optical characteristics of the projection light, a polarization plate, a dimming element for reducing the light intensity of the light emitted by the light source on a path leading to the light modulation device 12, and so on (all not shown).

The light modulation device 12 corresponds to a modulation section for modulating the light emitted from the light source section 11 based on the image data. The light modulation device 12 has a configuration using a liquid crystal panel. The light modulation device 12 is provided with a transmissive liquid crystal panel having a plurality of pixels arranged in a matrix, and modulates the light emitted by the light source. The light modulation device 12 is driven by a light modulation device drive section 23, and varies the light transmittance in each of the pixels arranged in a matrix to thereby form the image.

The projection optical system 13 is provided with a zoom lens for performing expansion/contraction of the image to be projected and an adjustment of the focus, a focus adjustment mechanism for performing an adjustment of the focus, and so on. The projection optical system 13 projects the image light, which has been modulated by the light modulation device 12, on the target object to form the image.

To the display section 10, there are connected a light source drive section 22 and the light modulation device drive section 23.

The light source drive section 22 drives the light source provided to the light source section 11 in accordance with the control by a control section 30. The light modulation device drive section 23 drives the light modulation device 12 in accordance with the image signal input from an image processing section 25A described later in accordance with the control by the control section 30 to draw the image on the liquid crystal panel.

The image processing system of the projector 1 is configured with the control section 30 for controlling the projector 1 as a main constituent. The projector 1 is provided with a storage section 54 storing data to be processed by the control section 30 and a control program executed by the control section 30. Further, the projector 1 is provided with a remote control receiver 52 for detecting an operation by a remote controller 5, and is further provided with an input processing section 53 for detecting an operation via an operation panel 51 or the remote control receiver 52. The storage section 54 is a nonvolatile memory such as a flash memory or an EEPROM.

The control section 30 is configured including a central processing unit (CPU), a read only memory (ROM), a random access memory (RAM), and so on not shown. The control section 30 controls the projector 1 by the CPU executing a basic control program stored in the ROM and the control program stored in the storage section 54. Further, the control section 30 executes the control program stored in the storage section 54 to thereby achieve the functions of a projection control section 31 and a correction control section 32.

The main body of the projector 1 is provided with the operation panel 51 having a variety of switches and indicator lamps for the user to perform operations. The operation panel 51 is connected to the input processing section 53. The input processing section 53 appropriately lights or blinks the indicator lamps of the operation panel 51 in accordance with the operation state and the setting state of the projector 1 in accordance with the control of the control section 30. When the switch of the operation panel 51 is operated, an operation signal corresponding to the switch having been operated is output from the input processing section 53 to the control section 30.

Further, the projector 1 has the remote controller 5 to be used by the user. The remote controller 5 is provided with a variety of types of buttons, and transmits an infrared signal in accordance with the operation of these buttons. The main body of the projector 1 is provided with the remote control receiver 52 for receiving the infrared signal emitted by the remote controller 5. The remote control receiver 52 decodes the infrared signal received from the remote controller 5 to generate an operation signal representing the operation content in the remote controller 5, and then outputs the operation signal to the control section 30.

The image processing section 25A obtains input image data D in accordance with the control of the control section 30 to determine an attribute such as the image size, the resolution, whether the image is a still image or the moving image, and the frame rate in the case in which the image is a moving image with respect to the input image data D, and so on. The image processing section 25A develops the image in the frame memory 27 frame by frame, and then performs image processing on the image having been developed. The image processing section 25A reads out the image having been processed from the frame memory 27, generates image signals of R, G, and B corresponding to the image, and then outputs the image signals to the light modulation device drive section 23.

The processes performed by the image processing section 25A are, for example, a resolution conversion process, a digital zoom process, a color correction process, a luminance correction process, and a geometric correction process. Further, the image processing section 25A performs a drawing process for drawing an image in the frame memory 27 based on the input image data D input from the I/F section 24, a generation process for reading out the image from the frame memory 27 to generate the image signal, and so on. Further, it is obviously possible for the image processing section 25A to perform two or more of the processes described above in combination with each other.

Further, the projector 1 is provided with a wireless communication section 55. The wireless communication section 55 is provided with an antenna, an RF (radio frequency) circuit, and so on not shown, and performs the wireless communication with an external device under the control of the control section 30. As the wireless communication method of the wireless communication section 55, there can be adopted, for example, a near field communication method such as a wireless local area network (LAN), Bluetooth (registered trademark), UWB (ultra wide band), or infrared communication, or a wireless communication method using a mobile telephone line.

The projection control section 31 controls the light source drive section 22, the light modulation device drive section 23, and the image processing section 25A to project the image based on the input image data D on the target object.

The correction control section 32 controls the image processing section 25A to perform the geometric correction process in the case in which, for example, the input processing section 53 detects an instruction of the geometric correction process by the remote controller 5 or the operation panel 51, and the operation data representing the instruction of the geometric correction process has been input.

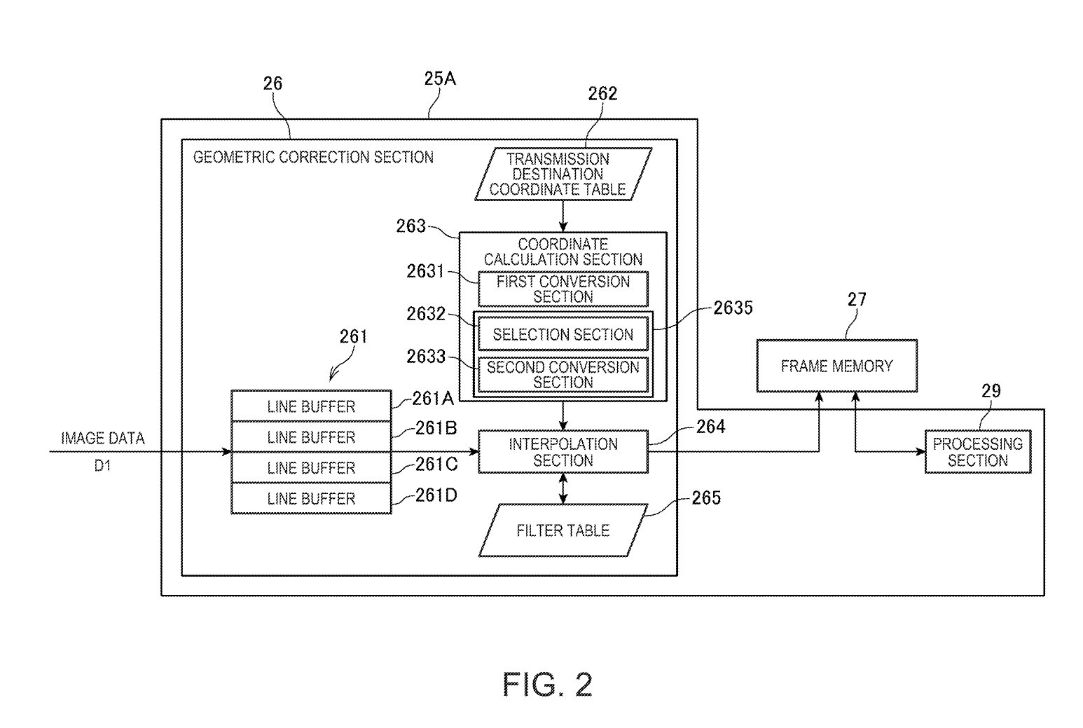

FIG. 2 is a configuration diagram of the image processing section 25A of the first embodiment. The image processing section 25A is provided with a geometric correction section (image deformation section) 26 and a processing section 29.

The geometric correction section 26 performs the geometric correction process on the input image data D to store the image data having been corrected to the frame memory 27.

The processing section 29 reads out the image having been processed by the geometric correction section 26 from the frame memory 27, and then performs at least either one of resolution conversion, digital zoom, a color correction, and a luminance correction on the image.

The geometric correction section 26 is provided with line buffers 261, a transmission destination coordinate table 262, a coordinate calculation section 263, an interpolation section 264 acting as an output section, and a filter table 265. Further, the coordinate calculation section 263 is provided with a first conversion section (conversion section) 2631, and an association section 2635. The association section 2635 is provided with a selection section 2632 and a second conversion section 2633.

The line buffers 261 include a line buffer 261A, a line buffer 261B, a line buffer 261C, and a line buffer 261D. Each of the line buffers 261A, 261B, 261C, and 261D stores image data corresponding to one line in the horizontal direction. In other words, the line buffers 261 of the present embodiment store the image data corresponding to four lines in the horizontal direction. Hereinafter, the image data, which is input from the I/F section 24, stored in the line buffers 261, and corresponds to a plurality of lines in the horizontal direction, is described as image data D1.

The pixel data of each of the pixels constituting the image data D1 is included in the image data D1. The pixel data includes pixel position information representing the pixel position of each of the pixels and the pixel value of each of the pixels.

Although FIG. 2 shows the line buffers 261 including the four line buffers 261A, 261B, 261C, and 261D, the number of the line buffers 261 is not limited to four, but can be increased and decreased in accordance with the number of pixels necessary for the interpolation process of the interpolation section 264.

The coordinate conversion information is registered in the transmission destination coordinate table 262. The coordinate conversion information is information obtained by calculating coordinates on the image (hereinafter referred to as a post-correction image), on which the geometric correction has been performed, with respect to representative points of the image (hereinafter referred to as a pre-correction image), on which the geometric correction has not been performed, and associating the coordinates of the representative points on the pre-correction image and the coordinates of the representative points on the post-correction image with each other.

It should be noted that the case of performing the keystone distortion correction as an example of the geometric correction process will hereinafter be described. Further, hereinafter, the keystone distortion correction is referred to simply as a correction.

The coordinate conversion information is calculated by the control section 30 of the projector 1, and is registered in the transmission destination coordinate table 262.

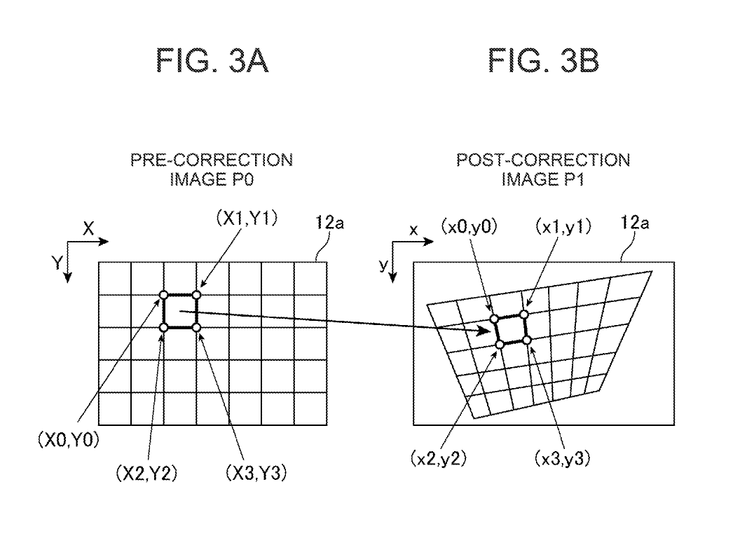

FIGS. 3A and 3B are explanatory diagrams of the calculation method of the coordinate conversion information, wherein FIG. 3A shows the pre-correction image P0 drawn in a pixel area 12a of the liquid crystal panel provided to the light modulation device 12, and FIG. 3B shows the post-correction image P1 drawn in the pixel area 12a.

In the present embodiment, as shown in FIG. 3A, the pre-correction image P0 is divided into rectangular blocks each formed of L×L (L is an arbitrary natural number) pixels, and the grid points of each of the blocks obtained by the division are defined as the representative points. The coordinates on the post-correction image P1 are calculated with respect to the grid points of each of the blocks obtained by the division, and the coordinate on the pre-correction image P0 and the coordinate on the post-correction image P1 are registered in the transmission destination coordinate table 262 so as to be associated with each other. It should be noted that a Cartesian coordinate system set in the pre-correction image P0 is defined as an X-Y coordinate system, and a Cartesian coordinate system set in the post-correction image P1 is defined as an x-y coordinate system.

For example, the coordinates of the grid points (X0, Y0), (X1, Y1), (X2, Y2), and (X3, Y3) of the block on the pre-correction image P0 shown in FIG. 3A and the coordinates of the grid points (x0, y0), (x1, y1), (x2, y2), and (x3, y3) of the block on the post-correction image P1 shown in FIG. 3B are respectively associated with each other.

The coordinate conversion information stored in the transmission destination coordinate table 262 is not limited to the information described above. For example, it is also possible to use the coordinate of a reference point on the post-correction image P1 and the distances between the reference point and the grid points as the information for identifying the positions of the grid points of the block on the post-correction image P1. As the reference point, the grid points located at the upper left of each of the blocks or the center point of each of the blocks, for example, can be used.

Before explaining the coordinate calculation section 263, an interpolation process according to the related art will be described.

In the case of performing the geometric correction process such as a keystone distortion correction, the pre-correction image P0 and the post-correction image P1 generally fail to be in a correspondence relationship of the integral multiple. Therefore, the pixel values of the pixels on the pre-correction image P0 cannot be used directly as the pixel values of the pixels (hereinafter referred to as output pixels) on the post-correction image P1. Therefore, in the geometric correction process according to the related art, the coordinate (X, Y) (the coordinate values are not integers in many cases) on the pre-correction image P0 is obtained from the coordinate (x, y) of the output pixel, and then the pixel value of the coordinate (X, Y) of the pre-correction image P0 thus obtained is obtained by an interpolation process using the pixel values of a plurality of pixels in the vicinity of that coordinate (X, Y). The pixel value in the coordinate (X, Y) of the pre-correction image P0 thus obtained corresponds to the pixel value of the output pixel (x, y). In the case of such a processing method, since the pixel values of the input image data D are randomly referred to, the input image data D is once stored in the frame memory, and then the geometric correction process is performed.

For example, in the case of performing the interpolation process using a 4×4 tap filter, 4×4 pixels are read from the frame memory with respect to each of the output pixels. Further, in the case of a four-phase process for processing four output pixels at the same time, 7×4 pixels are read from the frame memory at the same time to perform the interpolation process. Further, in the case of performing the geometric correction of contracting the horizontal size of the image by half, the number of pixels read at the same time further increases, and 10×4 pixels are read at the same time from the frame memory. Further, in the case in which the maximum value of the tilt caused in the image is assumed to be 45 degrees, and the geometric correction of contracting the image by half in the horizontal direction is performed as the geometric correction, 10×10 pixels are read at the same time from the frame memory. Therefore, in the interpolation process of the related art, since the pixel values of the plurality of pixels of the input image data D are read, the frame memory for storing the image data corresponding to one frame is disposed in the anterior stage of the geometric correction section, and the geometric correction section reads the image data from the frame memory. Therefore, there is a problem that there increases the band load of the bus, which connects the frame memory storing the image data and the geometric correction section to each other.

The coordinate calculation section 263 of the present embodiment calculates the coordinate of the output pixel on the post-correction image P1, the pixel value of which can be calculated, from the image data D1 of a plurality of lines stored in the line buffers 261. The coordinate calculation section 263 converts the coordinate of the output pixel thus calculated into the coordinate on the pre-correction image P0, and then notifies the interpolation section 264 of the result. The interpolation section 264 calculates the pixel value of the coordinate on the pre-correction image P0, of which the coordinate calculation section 263 has notified the interpolation section 264, based on the pixel value of the pixel having been read from the line buffers 261. Therefore, in the present embodiment, it is possible to reduce the number of pixels used by the interpolation section 264 in the interpolation process to thereby reduce the increase in band load of the bus connecting the line buffers 261 and the interpolation section 264 to each other.

Each of the sections constituting the coordinate calculation section 263 will be described. The first conversion section 2631 converts the coordinates of the pixels constituting the pre-correction image P0 into the coordinates on the post-correction image P1. The pixels constituting the pre-correction image P0 are each disposed at a position where the coordinate values are integers on the pre-correction image P0, and no pixel exists at a position where a decimal point is included in either of the coordinate values on the pre-correction image P0. Further, there is included the case in which a “coordinate” on the post-correction image P1 has a coordinate value including a decimal point. The selection section 2632 selects the output pixels constituting the post-correction image P1 based on the coordinates on the post-correction image P1 of the pixels constituting the pre-correction image P0. The second conversion section 2633 calculates the coordinates on the pre-correction image P0 of the output pixels selected by the selection section 2632.

The processing of the first conversion section 2631, the selection section 2632, and the second conversion section 2633 will hereinafter be describe in detail.

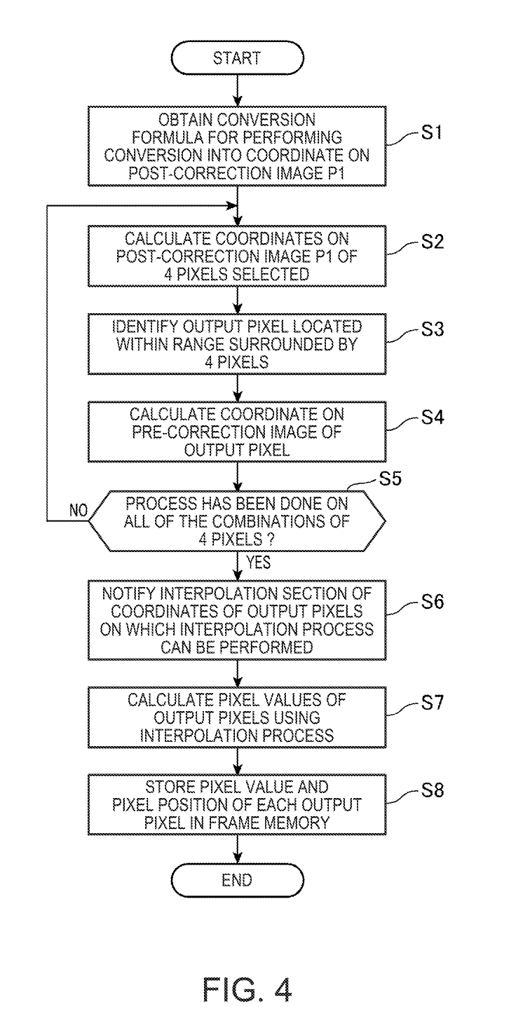

FIG. 4 is a flowchart showing a processing procedure of the geometric correction section 26 of the first embodiment.

Firstly, the first conversion section 2631 looks up the transmission destination coordinate table 262 to calculate (step S1) a conversion formula of linear transformation for converting the coordinate (X, Y) on the pre-correction image P0 into the coordinate (x, y) on the post-correction image P1.

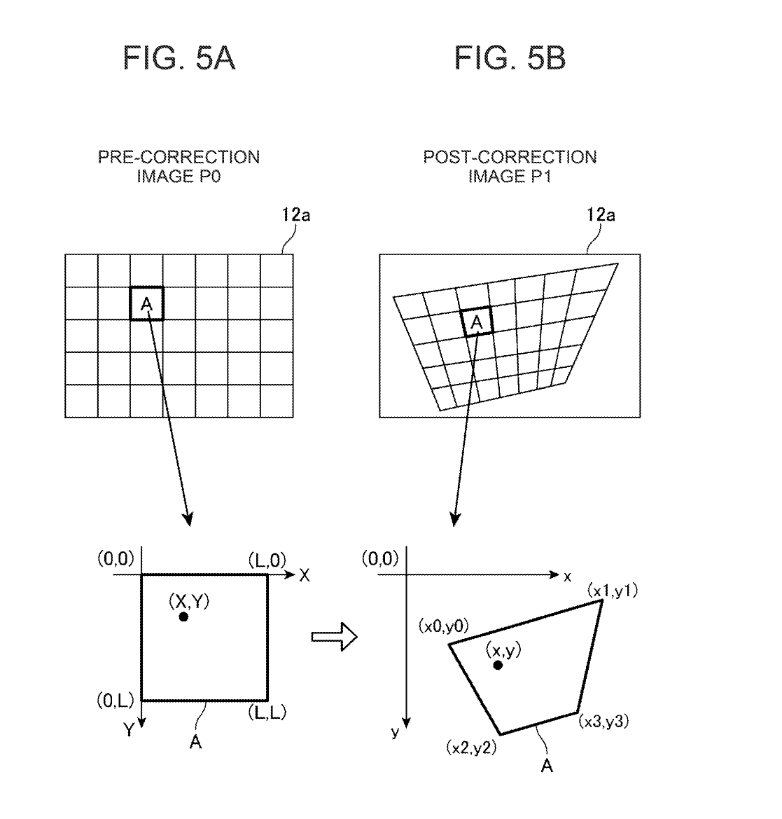

FIGS. 5A and 5B are explanatory diagrams of the geometric correction process, wherein FIG. 5A shows an enlarged view obtained by enlarging the block A, which is one of the blocks constituting the pre-correction image P0, and FIG. 5B shows an enlarged view of the block A on the post-correction image P1. Due to the correction, the block A on the pre-correction image P0 is corrected into the block A on the post-correction image P1. Further, a bunch of L×L (L is an arbitrary natural number) pixels is described as a block. Formulas (1) and (2) are the conversion formulas of the linear transformation for converting the coordinate (X, Y) in the block A shown in FIG. 5A into the coordinate (x, y) of the post-correction image P1.

$$\begin{matrix}x = \frac{X ( L - Y ) x {1}^{′} + Y ( L - Y ) x {2}^{′} + XYx {3}^{′}}{{L}^{2}} + x 0 & ( 1 ) \\ y = \frac{X ( L - Y ) y {1}^{′} + Y ( L - Y ) y {2}^{′} + XYy {3}^{′}}{{L}^{2}} + y 0 & ( 2 )\end{matrix}$$

In order to simplify Formulas (1) and (2), there are substituted x1′=x1−x0, x2′=x2−x0, x3′=x3−x0, y1′=y1−y0, y2′=y2−y0, and y3′=y3−y0.

Further, the coordinate (X, Y) is a coordinate having the upper left point of the block A as the origin. In other words, the coordinate values from the origin (0, 0) of the pre-correction image P0 to the coordinate (X, Y) can be obtained by adding the distance from the origin to the grid point located at the upper left of the block A to the coordinate (X, Y). The coordinate (x, y) on the post-correction image P1 is a coordinate having the origin (0, 0) of the post-correction image P1 as the origin.

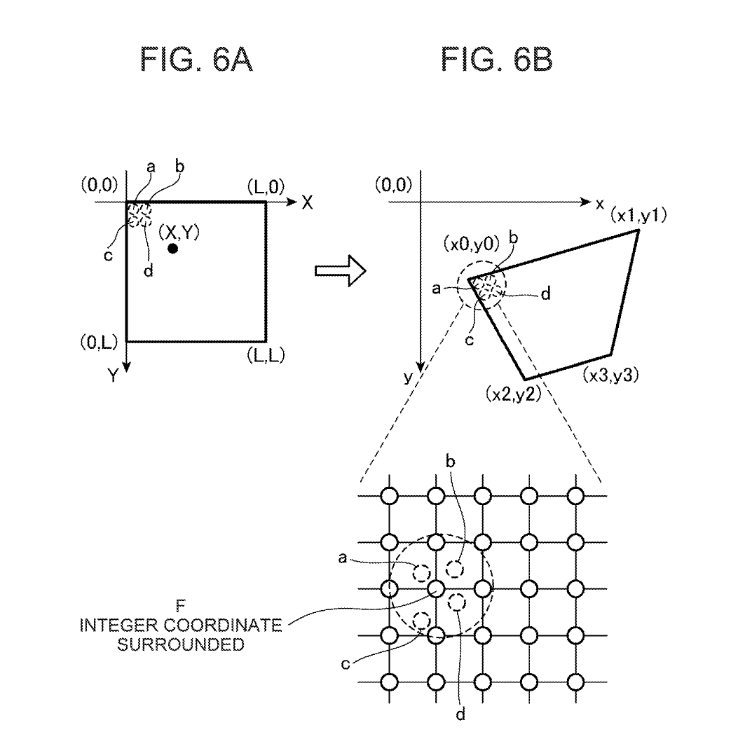

FIGS. 6A and 6B are explanatory diagrams of the geometric correction process, wherein FIG. 6A shows four pixels selected in the block A shown in FIG. 5A, and FIG. 6B shows the pixel positions of the selected four pixels on which the geometric correction has been performed.

Then, the selection section 2632 selects the four pixels (e.g., 2×2 pixels) of a small area in the block in the pre-correction image P0, and then calculates (step S2) the coordinate values on the post-correction image P1 of each of the four pixels thus selected using Formulas (1), (2). The four pixels thus selected are hereinafter referred to as pixels a, b, c, and d. FIG. 6A shows the four pixels a, b, c, and d selected on the pre-correction image P0. FIG. 6B shows the positions on the post-correction image P1 of the four pixels a, b, c, and d thus selected. Further, FIG. 6B shows the four pixels a, b, c, and d and pixels (hereinafter referred to integer pixels) each having the coordinate values expressed by integers and located around the four pixels a, b, c, and d in an enlarged manner.

Then, the selection section 2632 identifies (step S3) the integer pixel, which is located in a range surrounded by the four pixels a, b, c, and d on the post-correction image P1, as an output pixel. The pixel F surrounded by the four pixels a, b, c, and d shown in FIG. 6B becomes the output pixel F. In the case in which the output pixel F does not exist within the range surrounded by the four pixels a, b, c, and d on the post-correction image P1, the selection section 2632 selects the four pixels once again, and then repeats the process from the step S2.

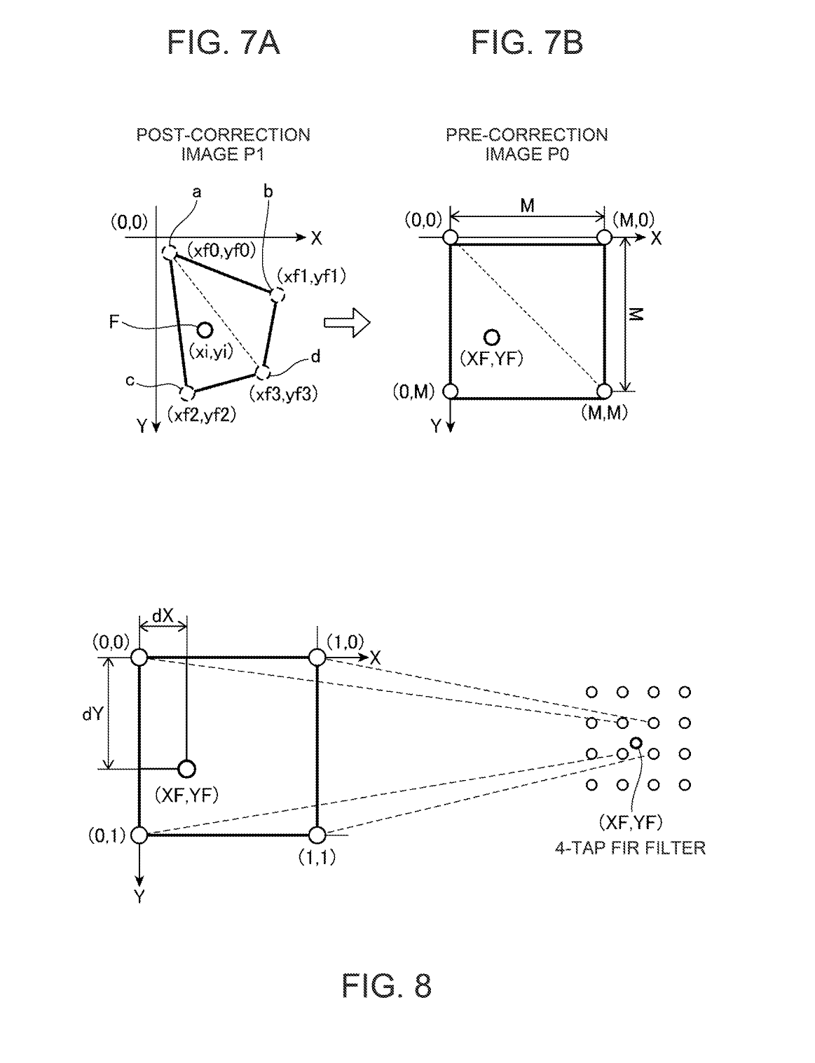

FIGS. 7A and 7B are explanatory diagrams of the geometric correction process, wherein FIG. 7A is a diagram showing the output pixel surrounded by the four pixels on the post-correction image P1, and FIG. 7B is a diagram showing the state in which the four pixels and the output pixel are restored to the state in which the correction has not been performed.

Then, the second conversion section 2633 calculates (step S4) the coordinate on the pre-correction image P0 of the output pixel F. The coordinates on the post-correction image P1 of the four pixels a, b, c, and d selected in the step S2 are described as a (xf0, yf0), b (xf1, yf1), c (xf2, yf2), and d (xf3, yf3). Further, the coordinate of the output pixel F identified in the step S3 is described as (xi, yi).

The second conversion section 2633 firstly determines whether the output pixel F is included in a triangular range surrounded by the pixels a (xf0, yf0), c (xf2, yf2), and d (xf3, yf3) out of the four pixels a, b, c, and d, or included in a triangular range surrounded by the pixels a (xf0, yf0), b (xf1, yf1), and d (xf3, yf3).

In the case in which the second conversion section 2633 determines that the output pixel F is included in the triangular range surrounded by the pixels a (xf0, yf0), c (xf2, yf2), and d (xf3, yf3), the second conversion section 2633 calculates the coordinate (XF, YF) on the pre-correction image P0 of the output pixel F (xi, yi) using Formulas (3), (4) described below. FIG. 7B shows the coordinate (XF, YF) on the pre-correction image P0 of the output pixel F (xi, yi). Formulas (3) and (4) are formulas obtained by obtaining a conversion formula of an affine transformation for restoring the coordinates on the post-correction image P1 of the four pixels a, b, c, and d to the coordinates on the pre-correction image P0, and then converting the output pixel F (xi, yi) into the coordinate (XF, YF) on the pre-correction image P0 using the conversion formula thus obtained. Further, the value of a character M shown in Formulas (3) and (4) is a value corresponding to a distance between the pixels, and in the case of assuming the coordinates of the 2×2 pixels adjacent on upper, lower, right, and left sides, the value of M becomes 1.

XF=M(yf2·xi−xf2·yi)/(xf3·yf2−xf2·yf3) (3)

YF=M(xf3·yi−yf3·xi)/(xf3·yf2−xf2·yf3) (4)

Further, in the case in which the output pixel F is included in the triangular range surrounded by the pixels a (xf0, yf0), b (xf1, yf1), and d (xf3, yf3), the coordinate calculation section 263 obtains the conversion formula for calculating the coordinate (XF, YF) on the pre-correction image P0 of the output pixel F (xi, yi) using Formulas (5), (6) described below. Formulas (5) and (6) are formulas obtained by obtaining a conversion formula of an affine transformation for restoring the coordinates on the post-correction image P1 of the four pixels a, b, c, and d to the coordinates on the pre-correction image P0, and then converting the output pixel F (xi, yi) into the coordinate (XF, YF) on the pre-correction image P0 using the conversion formula thus obtained. Further, the value of the character M shown in Formulas (5) and (6) is a value corresponding to a distance between the pixels, and in the case of assuming the coordinates of the 2×2 pixels adjacent on upper, lower, right, and left sides, the value of M becomes 1.

XF=M(yf3·xi−xf3·yi)/(xf1·yf3−xf3·yf1) (5)

YF=M(xf1·yi−yf1·xi)/(xf1·yf3−xf3·yf1) (6)

Further, in the case in which there exist two or more output pixels surrounded by the coordinates on the post-correction image P1 of the four pixels a, b, c, and d, the coordinate calculation section 263 calculates the coordinate (XF, YF) on the pre-correction image P0 with respect to each of the output pixels.

It should be noted that in the present embodiment, the affine transformation is used instead of a linear transformation when calculating the coordinate on the pre-correction image P0 of the output pixel F. This is because the calculation for obtaining the inverse function of the conversion formula of the linear transformation is complicated, and therefore, the coordinate on the pre-correction image P0 of the output pixel F is calculated using the affine transformation.

Then, the coordinate calculation section 263 determines (step S5) whether or not the process of the steps S2 through S4 described above is performed in all of the combinations of the four pixels included in the pre-correction image P0. In the case of the negative determination (NO in the step S5), the coordinate calculation section 263 returns to the process of the step S2, and performs the process of the steps S2 through S4 with respect to one of other combinations not having been selected of the four pixels.

In the case in which the determination in the step S5 is a positive determination (YES in the step S5), the coordinate calculation section 263 notifies the interpolation section 264 of the coordinate (XF, YF) of the output pixel F. The coordinate calculation section 263 notifies (step S6) the interpolation section 264 of the coordinate (XF, YF) of the output pixel F on which the interpolation process can be performed based on the image data D1 stored in the line buffers 261 out of the coordinates (XF, YF) of the output pixels F on the pre-correction image P0 thus calculated. For example, in the case in which the interpolation process by the interpolation section 264 is the interpolation process using the 4 tap filter, 4×4 pixels of the image data D1 become necessary. Therefore, the coordinate calculation section 263 selects the output pixel F, and then notifies the interpolation section 264 of the output pixel F, wherein the pixel data of the 4×4 pixels located around the selected output pixel F is stored in the line buffers 261.

In the filter table 265, there are registered a filter coefficient in the X-axis direction and a filter coefficient in the Y-axis direction used by the interpolation section 264 in the interpolation process. The filter coefficients are the coefficients for obtaining the pixel value by the interpolation process with respect to the pixel, for which corresponding one of the pixels of the pre-correction image P0 cannot be identified, among the output pixels constituting the post-correction image P1. For example, in the filter table 265, there are registered the filter coefficients of vertically/horizontally separated one-dimensional filters.

FIG. 8 is an explanatory diagram of the interpolation process, and shows the output pixel (XF, YF) and the four integer pixels (0, 0), (0, 1), (1, 0), and (1, 1) located on the pre-correction image P0 and surrounding the output pixel (XF, YF). In the case of dividing the distance between the integer pixels in each of the X-axis direction and the Y-axis direction shown in FIG. 8 into 32 equal parts, the 32 filter coefficients are prepared in each of the X-axis direction and the Y-axis direction. For example, in the case in which the coordinate value (dX shown in FIG. 8) in the X-axis direction of the output pixel (XF, YF) is 0.5, the filter coefficient corresponding to 16/32 is selected. Further, in the case of assuming the number of the filter coefficient as 32, and the tap number of the interpolation filter as 4, the total number of the filter coefficients in the X-axis direction becomes 32×4=128. Regarding the Y-axis direction, in the case of assuming the tap number of the interpolation filter as 4, 128 filter coefficients are prepared.

The interpolation section 264 calculates (step S7) the pixel values in the coordinate on the pre-correction image P0 of the output pixel F (XF, YF) having been notified of by the coordinate calculation section 263 using the interpolation process. In the case in which, for example, the tap number of the interpolation filter used by the interpolation section 264 in the interpolation process is 4, the interpolation section 264 uses the 4×4 pixels located in the periphery of the output pixel F (XF, YF) in the interpolation process as shown in FIG. 8. Further, the interpolation section 264 selects the filter coefficient of the interpolation filter based on the distance (dX, dY) between the output pixel F (XF, YF) and, for example, the integer pixel located upper left of the output pixel F. The interpolation section 264 performs a convolution operation of the pixel value of the pixel thus selected and the filter coefficient of the interpolation filter thus selected to calculate the pixel value of the output pixel F (XF, YF). When the interpolation section 264 calculates the pixel value, the interpolation section 264 stores (step S8) the pixel value and the pixel position (xi, yi) of the output pixel F thus calculated in the frame memory 27 (step S8).

### Second Embodiment

In the present embodiment, an integer pixel having integral coordinate values and located in a range surrounded by the coordinates on the post-correction image P1 of the four pixels a, b, c, and d is identified as the output pixel, and then the pixel value of the pixel, which has the closest distance from the output pixel out of the four pixels a, b, c, and d, is selected as the pixel value of the output pixel.

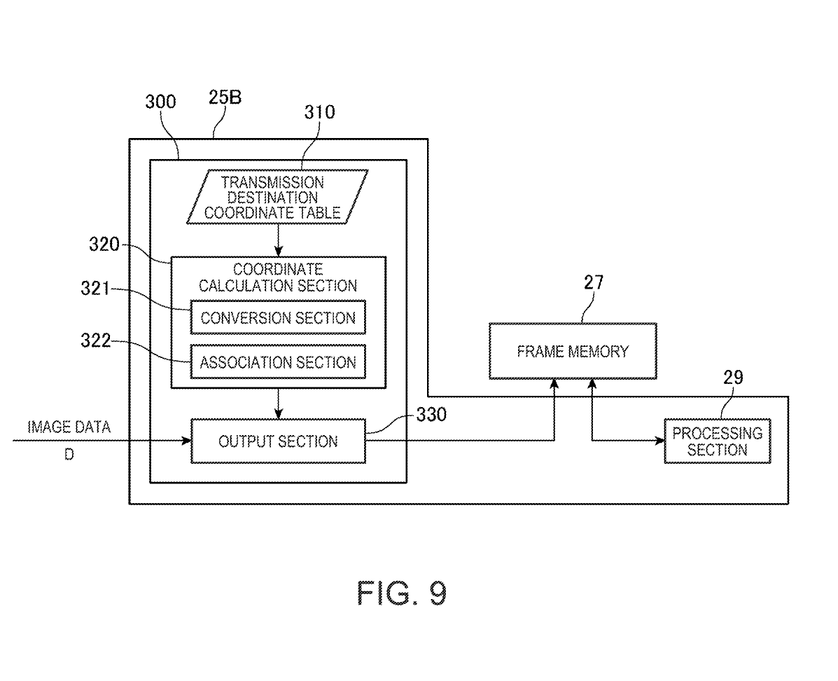

FIG. 9 is a configuration diagram of an image processing section 25B of the second embodiment.

The geometric correction section 300 of the present embodiment is provided with a transmission destination coordinate table 310, a coordinate calculation section 320, and an output section 330. Further, the coordinate calculation section 320 is provided with a conversion section 321, and an association section 322.

The conversion section 321 converts the coordinates of the pixels on the pre-correction image P0 into the coordinates on the post-correction image P1. Therefore, the conversion section 321 performs the same process as the process of the first conversion section 2631 described above.

The association section 322 associates the pixels constituting the post-correction image P1 with the pixels constituting the pre-correction image P0 based on the coordinates on the post-correction image P1 of the pixels on the pre-correction image P0.

The output section 330 inputs the pixel data of the image data D, and then identifies the pixel position of the pixel on the post-correction image P1, the pixel value of which can be identified based on the pixel data thus input.

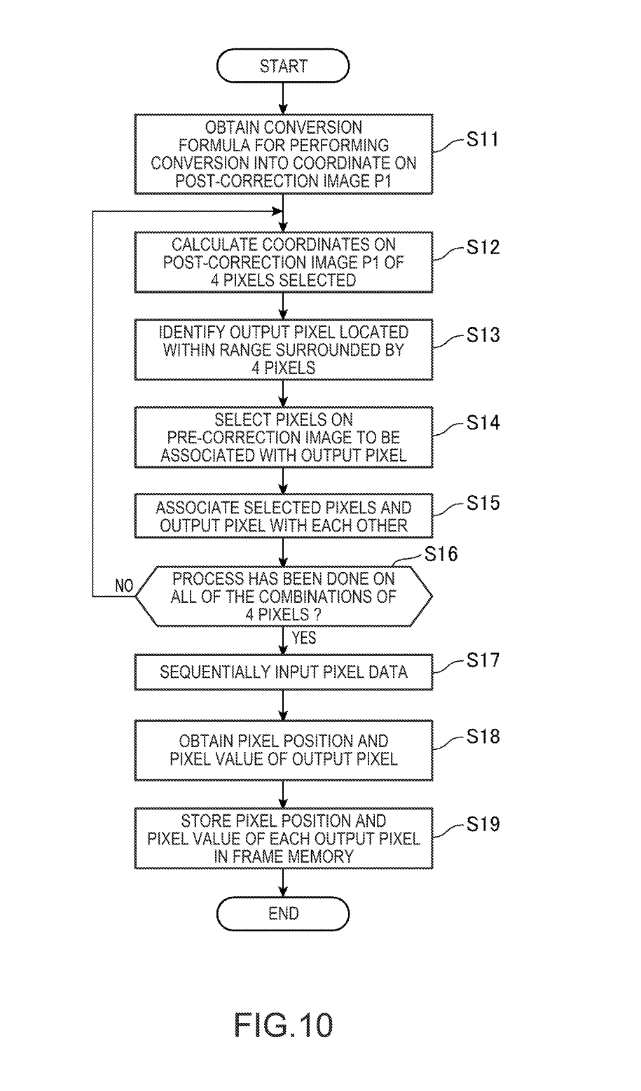

FIG. 10 is a flowchart showing a processing procedure of the geometric correction section of the second embodiment. The processing procedure of the association section 322 and the output section 330 will be described with reference to the flowchart shown in FIG. 10. It should be noted that the process in the step S13 and the preceding steps shown in FIG. 10 are the same as the process in the step S3 and the preceding steps shown in FIG. 4, and therefore, the explanation thereof will be omitted.

The association section 322 identifies (step S13) the integer pixel, which is located in a range surrounded by the coordinates on the post-correction image P1 of the four pixels a, b, c, and d, as the output pixel. Then, the association section 322 selects (step S14) the pixel on the pre-correction image P0 to be associated with the output pixel thus identified. The association section 322 selects the pixel having the closest distance from the output pixel thus identified out of the four pixels a, b, c, and d on the post-correction image P1. Hereinafter, the pixel selected by the association section 322 is referred to as a selection pixel. When the association section 322 selects the selection pixel, the association section 322 associates (step S15) the selection pixel and the output pixel with each other. Specifically, the association section 322 associates the pixel position on the pre-correction image P0 of the selection pixel and the pixel position on the post-correction image P1 of the output pixel with each other. The information thus associated is stored in a memory not shown by the association section 322.

Then, the coordinate calculation section 320 determines (step S16) whether or not the process of the steps S12 through S15 is performed in all of the combinations of the four pixels included in the pre-correction image P0. In the case of the negative determination (NO in the step S16), the coordinate calculation section 320 returns to the process of the step S12, and performs the process of the steps S12 through S15 with respect to one of combinations of the four pixels not having been selected.

In the case in which the determination in the step S16 is a positive determination (YES in the step S16), the output section 330 sequentially inputs the pixel data of each of the pixels constituting the image data D. The output section 330 obtains (step S17) the pixel position and the pixel value of the corresponding output pixel in the order of inputting the pixel data. The output section 330 selects the pixel on the pre-correction image P0 at the same pixel position based on the information of the pixel position included in the pixel data thus input. The output section 330 selects the pixel on the pre-correction image P0, and then determines whether or not there exists the pixel on the post-correction image P1 associated with the pixel thus selected with reference to the memory. In the case in which the pixel on the post-correction image P1 associated with the pixel selected does not exist, the output section 330 terminates the process to the pixel data thus input, and then starts the process to the pixel data subsequently input. Further, in the case in which there exists the pixel on the post-correction image P1 associated with the pixel thus selected, the output section 330 sets the pixel position on the post-correction image P1 as the pixel position of the output pixel. Further, the output section 330 sets the pixel value of the pixel data thus input as the pixel value of the output pixel.

The output section 330 obtains the pixel position and the pixel value of the output pixel, and then, outputs the pixel position and the pixel value of the output pixel thus obtained to the frame memory 27 to thereby store (step S19) the pixel position and the pixel value in the frame memory 27. The output section 330 sequentially inputs the pixel data, and then outputs the pixel position and the pixel value of each of the corresponding output pixels to the frame memory 27 in the order of inputting the pixel data. Therefore, in the present embodiment, there is no need to dispose the frame memory and the line buffer in the anterior stage of the geometric correction section 300, and the geometric correction can efficiently be performed.

As described hereinabove, the image processing section 25A of the first embodiment to which the invention is applied is provided with the first conversion section (the conversion section) 2631, the selection section 2632, the second conversion section 2633 as the association section, and the interpolation section (the output section) 264.

The first conversion section 2631 converts the coordinates of the pixels constituting the pre-correction image P0 into the coordinates on the post-correction image P1 obtained by performing the geometric correction on the pre-correction image P0.

The selection section 2632 selects the output pixels constituting the post-correction image P1 based on the coordinates on the post-correction image P1 of the pixels constituting the pre-correction image P0.

The second conversion section 2633 converts the coordinate of the output pixel into the coordinate on the pre-correction image P0.

The interpolation section 264 calculates the pixel value of the output pixel based on the coordinate on the image of the output pixel.

Therefore, since it is sufficient to refer to the pixels constituting the image based on the coordinates on the post-correction image P1, it is possible to suppress the number of the pixels to be referred to for the geometric correction to perform the efficient geometric correction.

Further, the selection section 2632 selects the pixel, which is located in an area surrounded by the coordinates on the post-correction image P1 of a plurality of pixels constituting the pre-correction image P0, and has integral coordinate values, as the output pixel. Therefore, the association between the output pixel and the pixels constituting the image can easily be performed.

Further, the first conversion section 2631 converts the coordinates of the pixels constituting the pre-correction image P0 into the coordinates on the post-correction image P1 based on the linear transformation. Therefore, the coordinates of the pixels constituting the pre-correction image P0 can easily be converted into the coordinates on the post-correction image P1.

Further, the second conversion section 2633 converts the coordinate of the output pixel into the coordinate on the per-correction image P0 based on the affine transformation. Therefore, the coordinate of the output pixel can easily be converted into the coordinate on the image.

The image processing section 25B of the second embodiment to which the invention is applied is provided with the conversion section 321, the association section 322, and the output section 330.

The conversion section 321 converts the coordinates of the pixels constituting the pre-correction image P0 into the coordinates on the post-correction image P1 obtained by performing the geometric correction on the pre-correction image P0.

The association section 322 associates the pixels constituting the post-correction image P1 with the pixels constituting the pre-correction image P0 based on the coordinates on the post-correction image P1 of the pixels constituting the pre-correction image P0.

The output section 330 inputs the pixel data of the pixels constituting the image of the correction target to identify the pixels constituting the post-correction image P1 associated with the pixels constituting the pre-correction image P0 identified based on the pixel data thus input. Further, the output section 330 outputs the pixel position in the post-correction image P1 of the pixel thus identified and the pixel value determined based on the pixel value of the pixel data thus input as the pixel position and the pixel value of the output pixel.

Therefore, it is possible to suppress the number of pixels to be referred to for the geometric correction to perform the efficient geometric correction.

Further, the output section 330 sequentially inputs the pixel data of the pixels constituting the correction target image, and then outputs the pixel position and the pixel value of each of the corresponding output pixels in the order of inputting the pixel data. Therefore, since the output pixels are output in the order of inputting the pixel data, the geometric correction can efficiently be performed.

Further, the association section 322 selects the pixel, which is located in the area surrounded by the coordinates on the post-correction image P1 of the plurality of pixels constituting the pre-correction image P0, and has integral coordinate values, as the pixel constituting the post-correction image P1. Then, the association section 322 associates the pixel, which is the closest to the pixel constituting the post-correction image P1 and having the coordinate on the post-correction image P1 having been selected out of the plurality of pixels, with the pixel, which constitutes the post-correction image P1 and has been selected. Therefore, the association between the pixel constituting the post-correction image P1 and the pixels constituting the pre-correction image P0 can easily be performed.

It should be noted that the embodiments described above are nothing more than examples of a specific aspect to which the invention is applied, and therefore, do not limit the invention. Therefore, it is also possible to apply the invention as an aspect different from the embodiments described above. Although in the embodiments, the explanation is presented showing the example of performing the keystone distortion correction (keystone correction) as an example of the geometric correction, the invention is not limited to this example, but can also be applied to the case of performing a barrel distortion correction (a pin-cushion distortion correction). Further, the invention can also be applied to the geometric correction process of deforming the image to a more complicated shape.

Further, although in the embodiments described above, the explanation is presented citing the configuration, in which the three transmissive liquid crystal panels corresponding respectively to the colors of R, G, and B are used as the light modulation device 12 for modulating the light emitted by the light source, as an example, the invention is not limited to this example. For example, it is also possible to adopt a configuration of using three reflective liquid crystal panels, or to use a system having a liquid crystal panel and a color wheel combined with each other. Alternatively, the invention can be constituted by a system using three digital mirror devices (DMD), a DMD system having a single digital mirror device and a color wheel combined with each other, or the like. In the case of using just one liquid crystal panel or DMD as the light modulation device, the member corresponding to the combining optical system such as the cross dichroic prism is unnecessary. Further, besides the liquid crystal panel or the DMD, any light modulation device capable of modulating the light emitted by the light source can be adopted without problems.

Further, although in the embodiments described above, there is described the front projection type projector 1 for performing the projection from the front of the screen SC as a device implementing the image processing device, the invention is not limited to this configuration. For example, a rear projection type projector for performing the projection from the backside of the screen SC can be adopted as the display device. Further, a liquid crystal display, an organic electroluminescence (EL) display, a plasma display, a cathode-ray tube (CRT) display, a surface-conduction electron-emitter display (SED), and so on can be used as the display device.

Further, each of the functional sections shown in FIGS. 1, 2, and 9 is for showing the functional configuration, and the specific implementation configuration is not particularly limited. In other words, it is not necessarily required to install the hardware corresponding individually to each of the functional sections, but it is obviously possible to adopt the configuration of realizing the functions of the plurality of functional sections by a single processor executing a program. Further, apart of the function realized by software in the embodiments described above can also be realized by hardware, or a part of the function realized by hardware can also be realized by software. Besides the above, the specific detailed configuration of each of other sections of the projector 1 can arbitrarily be modified within the scope or the spirit of the invention.

What is claimed is:

1. An image processing device adapted to perform a deformation of an image, comprising:
a conversion section adapted to convert a coordinate of a pixel constituting the image into a coordinate on a post-deformation image obtained by deforming the image;
an association section adapted to associate the pixel constituting the post-deformation image with the pixel constituting the image based on a coordinate on the post-deformation image of the pixel constituting the image; and
an output section adapted to input pixel data of the pixel constituting a deformation target image, identify the pixel, which constitutes the post-deformation image, and is associated with the pixel constituting the image and identified based on the pixel data input, and then output a pixel position in the post-deformation image of the pixel identified, and a pixel value determined based on a pixel value of the pixel data input as a pixel position and a pixel value of an output pixel.

2. The image processing device according to claim 1, wherein
the output section sequentially inputs the pixel data of the pixels constituting the deformation target image, and then outputs the pixel position and the pixel value of each of the corresponding output pixels in the order of inputting the pixel data.

3. The image processing device according to claim 1, wherein
the association section selects a pixel, which is located in an area surrounded by coordinates on the post-deformation image of a plurality of pixels constituting the image, and a coordinate value of which on the post-deformation image is an integer, as a pixel constituting the post-deformation image, and associates a pixel, which is the closest to the pixel constituting the post-deformation image, and the coordinate of which on the post-deformation image is selected out of the plurality of pixels, with the pixel, which constitutes the post-deformation image, and is selected.

4. An image processing device adapted to perform a deformation of an image, comprising:
a conversion section adapted to convert a coordinate of a pixel constituting the image into a coordinate on a post-deformation image obtained by deforming the image;
a selection section adapted to select an output pixel constituting the post-deformation image based on the coordinate on the post-deformation image of the pixel constituting the image;
an association section adapted to associate a coordinate of the output pixel with a coordinate on the image; and
a calculation section adapted to calculate a pixel value of the output pixel based on the coordinate on the image of the output pixel.

5. The image processing device according to claim 4, wherein
the selection section selects the pixel, which is located in an area surrounded by coordinates on the post-deformation image of a plurality of pixels constituting the image, and a coordinate value of which is an integer, as the output pixel.

6. The image processing device according to claim 4, wherein
the conversion section converts a coordinate of the pixel constituting the image into a coordinate on the post-deformation image based on a linear transformation.

7. The image processing device according to claim 4, wherein
the association section converts the coordinate of the output pixel into the coordinate on the image based on an affine transformation.

8. A display device adapted to perform a deformation of an image to display on a display section, comprising:
a conversion section adapted to convert a coordinate of a pixel constituting the image into a coordinate on a post-deformation image obtained by deforming the image;
an association section adapted to associate the pixel constituting the post-deformation image with the pixel constituting the image based on a coordinate on the post-deformation image of the pixel constituting the image;
an output section adapted to input pixel data of the pixel constituting a deformation target image, identify the pixel, which constitutes the post-deformation image, and is associated with the pixel constituting the image and identified based on the pixel data input, and then output a pixel position in the post-deformation image of the pixel identified, and a pixel value determined based on a pixel value of the pixel data input as a pixel position and a pixel value of an output pixel; and
an image processing section adapted to generate the post-deformation image based on the pixel position and the pixel value of the output pixel input from the output section to display on the display section.
